(19) United States
(12) Patent Application Publication
(10) Pub. No.: US 2022/0328969 A1
(43) Pub. Date: Oct. 13, 2022

(54) RADIATING ELEMENT AND MULTI-BAND BASE STATION ANTENNA

(71) Applicant: CommScope Technologies LLC, Hickory, NC (US)

(72) Inventors: Jian Zhang, Suzhou (CN); Bo Wu, Richardson, TX (US)

(21) Appl. No.: 17/695,997

(22) Filed: Mar. 16, 2022

(30) Foreign Application Priority Data
Apr. 13, 2021 (CN) 2021103929005

(51) Int. Cl. H01Q 9/28; H01Q 19/10; H01Q 9/04; H01Q 1/24; H01Q 1/38; H01Q 21/28

(52) U.S. Cl. CPC H01Q 9/285; H01Q 19/108; H01Q 9/045; H01Q 1/246; H01Q 1/38; H01Q 21/28

(57) ABSTRACT

A radiating element includes a radiator mounted on a feed stalk. The radiator includes a first dipole having first and second dipole arms and a second dipole having third and fourth dipole arms, where the first and second dipoles are in a cross-dipole arrangement. Each of the dipole arms includes a trunk conductive segment and a branch conductive segment, where one end of the branch conductive segment is connected to the trunk conductive segment and the other end is open. The branch conductive segment is configured such that a current induced by radiation in a preselected frequency range higher than an operating frequency range of the radiating element in a portion, to which the branch conductive segment is connected, of the trunk conductive segment of the dipole arm is opposite to a current induced in the branch conductive segment.

### CROSS-REFERENCE TO RELATED APPLICATION

The present application claims priority to Chinese Patent Application No. 202110392900.5, filed Apr. 13, 2021, the entire content of which is incorporated herein by reference as if set forth fully herein.

### FIELD

The present disclosure generally relates to the field of antennas, and more specifically, the present disclosure relates to radiating elements and to multi-band base station antennas.

### BACKGROUND

With the development of wireless communication technology, the requirements on integration and miniaturization of antennas become higher and higher, and it is usually necessary to arrange a large number of radiating elements operating in a variety of different frequency bands within a space as small as possible. This may cause radiating elements operating in different frequency bands to affect radiation performance of one another, making it challenging for multi-band antennas to maintain high performance while improving integration and miniaturization. For example, in some multi-band antenna applications, a low frequency band may be the 617 MHz to 960 MHz frequency range or a part thereof, a middle frequency band may be the 1.7 GHz to 2.7 GHz frequency range or a part thereof, and a high frequency band may be the 3.3 GHz to 4.2 GHz frequency range or a part thereof. In the limited space inside the antenna, the size of a low-band radiating element is often larger than the size of a mid-band radiating element which, in turn, is larger than the size of a high-band radiating element. As a result, in a case where a large number of radiating elements need to be arranged, a higher band radiating element sometimes has to be blocked by a lower band radiating element, potentially leading to significant deterioration of the radiation pattern of the higher band radiating element (and potentially the lower band radiating element as well).

### SUMMARY

According to an aspect of the present disclosure, a radiating element is provided which includes a feed stalk and a radiator mounted on the feed stalk, the radiator including: a first dipole arranged along a first axis and including a first dipole arm and a second dipole arm; and a second dipole arranged along a second axis perpendicular to the first axis and including a third dipole arm and a fourth dipole arm, wherein each of the first dipole arm to the fourth dipole arm includes a trunk conductive segment and a branch conductive segment at one end of which is connected to the trunk conductive segment and at the other end of which being open, the branch conductive segment is configured such that a current induced by radiation in a preselected frequency range higher than an operating frequency range of the radiating element in a portion, to which the branch conductive segment is connected, of the trunk conductive segment of the dipole arm is opposite to a current induced in the branch conductive segment.

In some embodiments, the branch conductive segments are connected to the respective trunk conductive segment of each of the first dipole arm to the fourth dipole arm at respective positions at which the current induced in the trunk conductive segment of the dipole arm by the radiation in the preselected frequency range higher than the operating frequency range of the radiating element reaches a maximum value.

In some embodiments, the branch conductive segment of each of the first dipole arm to the fourth dipole arm has a length between one-eighth to a quarter of a wavelength corresponding to a center frequency of the preselected frequency range higher than the operating frequency range of the radiating element.

In some embodiments, the number of branch conductive segments included in each of the first dipole arm to the fourth dipole arm is an even number.

In some embodiments, the branch conductive segments of each of the first dipole arm and the second dipole arm are arranged symmetrically about the first axis, and the branch conductive segments of each of the third dipole arm and the fourth dipole arm are arranged symmetrically about the second axis.

In some embodiments, the first dipole arm to the fourth dipole arm are rotationally symmetrical about an intersection of the first axis and the second axis.

In some embodiments, the branch conductive segments of each of the first dipole arm to the fourth dipole arm are all arranged inside a boundary defined by the trunk conductive segment of the dipole arm; or the branch conductive segments of each of the first dipole arm to the fourth dipole arm are all arranged outside the boundary defined by the trunk conductive segment of the dipole arm; or some of the branch conductive segments of each of the first dipole arm to the fourth dipole arm are arranged outside the boundary defined by the trunk conductive segment of the dipole arm, while others are arranged inside the boundary defined by the trunk conductive segment of the dipole arm; or the branch conductive segment of at least one of the first dipole arm to the fourth dipole arm overlaps with the trunk conductive segment of the dipole arm in length direction thereof.

In some embodiments, the branch conductive segment of each of the first dipole arm to the fourth dipole arm includes a first sub-branch conductive segment and a second sub-branch conductive segment, the first sub-branch conductive segment and the second sub-branch conductive segment are connected to the trunk conductive segment of the dipole arm at the same position, and wherein: the first sub-branch conductive segment is arranged inside a boundary defined by the trunk conductive segment of the dipole arm and the second sub-branch conductive segment is arranged outside the boundary defined by the trunk conductive segment of the dipole arm; or the first sub-branch conductive segment and the second sub-branch conductive segment are both arranged outside the boundary defined by the trunk conductive segment of the dipole arm; or the first sub-branch conductive segment and the second sub-branch conductive segment are both arranged inside the boundary defined by the trunk conductive segment of the dipole arm; or the first sub-branch conductive segment is arranged inside or outside the boundary defined by the trunk conductive segment of the dipole arm and the second sub-branch conductive segment overlaps with the trunk conductive segment of the dipole arm in length direction thereof.

In some embodiments, the trunk conductive segment of each of the first dipole arm to the fourth dipole arm comprises a single closed conductive segment.

In some embodiments, the trunk conductive segment of each of the first dipole arm to the fourth dipole arm comprises a first conductive segment and a second conductive segment which are connected to each other at their first ends proximal to the feed stalk and separated by a gap at their second ends opposite to the first ends.

In some embodiments, the first conductive segment and the second conductive segment collectively define an annular shape.

In some embodiments, the radiator further comprises a dielectric substrate, and wherein: the trunk conductive segment and the branch conductive segment are arranged on a same surface of the dielectric substrate; or the trunk conductive segment and the branch conductive segment are arranged on different surfaces of the dielectric substrate; or the dielectric substrate is a multilayer dielectric substrate, and the trunk conductive segment and the branch conductive segment are arranged on a same layer or different layers of the multilayer dielectric substrate.

In some embodiments, the radiator further comprises a dielectric substrate, and the trunk conductive segment comprises a plurality of portions, and wherein: the plurality of portions of the trunk conductive segment is arranged on a same surface of the dielectric substrate; or the plurality of portions of the trunk conductive segment is arranged on different surfaces of the dielectric substrate; or the dielectric substrate is a multilayer dielectric substrate, and the plurality of portions of the trunk conductive segment is arranged on a same layer or different layers of the multilayer dielectric substrate.

In some embodiments, the first dipole and the second dipole are sheet metal dipoles.

In some embodiments, each of the first dipole arm and the second dipole arm has a length on the first axis between 0.6 times to 0.7 times a wavelength corresponding to a center frequency of the operating frequency range of the radiating element, and/or each of the third dipole arm and the fourth dipole arm has a length on the second axis between 0.6 times to 0.7 times the wavelength corresponding to the center frequency of the operating frequency range of the radiating element.

In some embodiments, the branch conductive segment of at least one of the first dipole arm to the fourth dipole arm is configured such that a current induced by radiation in a preselected first frequency range higher than the operating frequency range of the radiating element in a portion, to which the branch conductive segment is connected, of the trunk conductive segment of the dipole arm is opposite to a current induced in the branch conductive segment, and the branch conductive segment of at least another one of the first dipole arm to the fourth dipole arm is configured such that a current induced by radiation in a preselected second frequency range higher than the operating frequency range of the radiating element in a portion, to which the branch conductive segment is connected, of the trunk conductive segment of the dipole arm is opposite to a current induced in the branch conductive segment, wherein the first frequency range is higher than the second frequency range.

In some embodiments, the branch conductive segment of each of the first dipole arm to the fourth dipole arm is configured such that a current induced by radiation in a respective one of a preselected plurality of frequency ranges higher than the operating frequency range of the radiating element in a portion, to which the branch conductive segment is connected, of the trunk conductive segment of the dipole arm is opposite to a current induced in the branch conductive segment, the respective ones of the plurality of frequency ranges being different from each other.

According to another aspect of the present disclosure, a multi-band base station antenna is provided which includes: a reflector; a first radiating element mounted on the reflector, the first radiating element being configured to operate in a first operating frequency range; and a second radiating element mounted on the reflector, the second radiating element being configured to operate in a second operating frequency range which is higher than the first operating frequency range, wherein, the first radiating element is the radiating element according to any one of embodiments of the aforementioned aspect of the present disclosure, and the branch conductive segment of each dipole arm of the first radiating element is configured such that a current induced by radiation in the second operating frequency range in a portion, to which the branch conductive segment is connected, of the trunk conductive segment of the dipole arm is opposite to a current induced in the branch conductive segment.

In some embodiments, a radiator of the first radiating element is farther from the reflector than a radiator of the second radiating element, and when viewed from a direction perpendicular to the surface of the reflector, the radiator of the first radiating element covers at least a part of the radiator of the second radiating element.

In some embodiments, the multi-band base station antenna includes a plurality of first radiating elements and a plurality of second radiating elements, and the plurality of first radiating elements and the plurality of second radiating elements are arranged such that, when viewed from a direction perpendicular to the surface of the reflector, each first radiating element at least partially overlaps with one or more second radiating elements.

In some embodiments, when viewed from a direction perpendicular to the surface of the reflector, each of the one or more second radiating elements with which each first radiating element at least partially overlaps is located below a corresponding dipole arm of that first radiating element.

In some embodiments, the second radiating element is a patch dipole radiating element.

In some embodiments, the multi-band base station antenna further includes a third radiating element mounted on the reflector, and the third radiating element is configured to operate in a third operating frequency range which is lower than the first operating frequency range.

In some embodiments, the third radiating element is configured to be cloaked to radiation in the first operating frequency range and/or the second operating frequency range.

In some embodiments, the third radiating element is the radiating element according to any one of embodiments of the aforementioned aspect of the present disclosure, and the branch conductive segment of each dipole arm of the third radiating element is configured such that a current induced by radiation in the first operating frequency range and/or the second operating frequency range in a portion, to which the branch conductive segment is connected, of the trunk conductive segment of the dipole arm is opposite to a current induced in the branch conductive segment.

In some embodiments, the third radiating element includes a cross dipole radiator, each dipole arm of the cross dipole radiator includes respective conductive segments and respective inductor capacitor circuits, and the inductor capacitor circuit defines a filter which is configured to allow radiation in the first operating frequency range and/or the second operating frequency range to pass.

In some embodiments, the third radiating element includes a cross dipole radiator, each dipole arm of the cross dipole radiator includes a plurality of dipole segments and chokes arranged between adjacent dipole segments of the plurality of dipole segments, and the chokes are configured to minimize the effect of current induced in the dipole arm of the third radiating element by radiation in the first operating frequency range and/or the second operating frequency range.

In some embodiments, a radiator of the third radiating element is farther from the reflector than a radiator of the first radiating element, the radiator of the first radiating element is farther from the reflector than a radiator of the second radiating element, and when viewed from a direction perpendicular to the surface of the reflector, the radiator of the third radiating element covers at least a part of the radiator of the first radiating element, and the radiator of the first radiating element covers at least a part of the radiator of the second radiating element.

In some embodiments, the multi-band base station antenna includes a plurality of first radiating elements, a plurality of second radiating elements, and a plurality of third radiating elements, and the plurality of first radiating elements, the plurality of second radiating elements, and the plurality of third radiating elements are arranged such that, when viewed from a direction perpendicular to the surface of the reflector, each third radiating element at least partially overlaps with one or more first radiating elements, and each first radiating element at least partially overlaps with one or more second radiating elements.

In some embodiments, when viewed from a direction perpendicular to the surface of the reflector, each of the one or more first radiating elements with which each third radiating element at least partially overlaps is located below a corresponding dipole arm of that third radiating element, and each of the one or more second radiating elements with which each first radiating element at least partially overlaps is located below a corresponding dipole arm of that first radiating element.

In some embodiments, a radiator of the third radiating element is farther from the reflector than a radiator of the first radiating element and is farther from the reflector than a radiator of the second radiating element, and when viewed from a direction perpendicular to the surface of the reflector, at least one of the dipole arms of the radiator of the third radiating element covers at least a part of the radiator of the first radiating element, and at least another one of the dipole arms of the radiator of the third radiating element covers at least a part of the radiator of the second radiating element, wherein the branch conductive segment of the at least one of the dipole arms of the radiator of the third radiating element is configured such that a current induced by radiation in the first operating frequency range in a portion, to which the branch conductive segment is connected, of the trunk conductive segment of the dipole arm is opposite to a current induced in the branch conductive segment, and the branch conductive segment of the at least another one of the dipole arms of the radiator of the third radiating element is configured such that a current induced by radiation in the second operating frequency range in a portion, to which the branch conductive segment is connected, of the trunk conductive segment of the dipole arm is opposite to a current induced in the branch conductive segment.

In some embodiments, the first operating frequency range is at least a portion of 1.7 GHz to 2.7 GHz frequency range, the second operating frequency range is at least a portion of 3.3 GHz to 4.2 GHz frequency range, and the third operating frequency range is at least a portion of 617 MHz to 960 MHz frequency range.

### BRIEF DESCRIPTION OF THE DRAWING

FIG. 1A is a top cross-sectional view of a radiating element according to some embodiments of the present disclosure.

FIG. 1B is a front view of an example of the radiating element in FIG. 1A.

FIG. 1C schematically shows the direction of an induced current in a dipole arm of the radiating element in FIG. 1A.

FIG. 1D, FIG. 1E, and FIG. 1F are front views of some other examples of the radiating element in FIG. 1A.

FIG. 2A to FIG. 2H respectively show exemplary arrangements of branch conductive segments of a dipole arm of a radiating element according to some embodiments of the present disclosure.

FIG. 3A is a perspective view of a multi-band base station antenna according to some embodiments of the present disclosure.

FIG. 3B is a top cross-sectional view of the multi-band base station antenna in FIG. 3A.

FIG. 4A and FIG. 4B respectively show exemplary layouts of a plurality of radiating elements of different frequency bands in the multi-band base station antenna in FIG. 3A.

FIG. 5A and FIG. 5B respectively show radiation patterns of a lower band radiating element and a higher band radiating element in the multi-band base station antenna in FIG. 3A.

FIG. 6 is a perspective view of a conventional multi-band base station antenna.

FIG. 7A and FIG. 7B respectively show radiation patterns of a lower band radiating element and a higher band radiating element in the conventional multi-band base station antenna in FIG. 6.

FIG. 8A is a perspective view of a multi-band base station antenna according to some embodiments of the present disclosure.

FIG. 8B is a top cross-sectional view of the multi-band base station antenna in FIG. 8A.

FIG. 8C is a front view of a low-band radiating element included in the multi-band base station antenna in FIG. 8A.

FIG. 9A to FIG. 9C respectively show exemplary layouts of a plurality of radiating elements of different frequency bands in the multi-band base station antenna in FIG. 8A.

FIG. 10A is a front view of a multi-band base station antenna according to some embodiments of the present disclosure.

FIG. 10B is a front view of a low-band radiating element included in the multi-band base station antenna in FIG. 10A.

FIG. 11 is a front view of a multi-band base station antenna according to some embodiments of the present disclosure.

Note, in the embodiments described below, the same signs are sometimes used in common between different attached drawings to denote the same parts or parts with the same functions, and repeated descriptions thereof are omitted. In some cases, similar labels and letters are used to indicate similar items. Therefore, once an item is defined in one attached drawing, it does not need to be further discussed in subsequent attached drawings.

For ease of understanding, the position, dimension, and range of each structure shown in the attached drawings and the like may not indicate the actual position, dimension, and range. Therefore, the present disclosure is not limited to the positions, dimensions, and ranges disclosed in the attached drawings and the like.

### DETAILED DESCRIPTION

Various exemplary embodiments of the present disclosure will be described in detail below by referencing the attached drawings. It should be noted: unless otherwise specifically stated, the relative arrangement, numerical expressions and numerical values of components and steps set forth in these embodiments do not limit the scope of the present disclosure.

The following description of at least one exemplary embodiment is actually only illustrative, and in no way serves as any limitation to the present disclosure and its application or use. In other words, the structure and method herein are shown in an exemplary manner to illustrate different embodiments of the structure and method in the present disclosure. However, those skilled in the art will understand that they only illustrate exemplary ways of implementing the present disclosure, rather than exhaustive ways. In addition, the attached drawings are not necessarily drawn to scale, and some features may be enlarged to show details of specific components.

In addition, the technologies, methods, and equipment known to those of ordinary skill in the art may not be discussed in detail, but where appropriate, the technologies, methods, and equipment should be regarded as part of the granted Specification. \

In all examples shown and discussed herein, any specific value should be construed as merely exemplary value and not as limiting value. Therefore, other examples of the exemplary embodiment may have different values.

In a multi-band antenna, radiating elements of different frequency bands may interfere with each other. Wireless communication technology has gradually developed from early 2G antennas that included only one or two RF ports to current 5G antennas that include dozens of RF ports. As more RF ports are included in an antenna, the requirements on integration become higher and higher. At the same time, it is also expected to maintain the miniaturization of the antenna while increasing the degree of integration of the antenna. These requirements result in an extremely complex electromagnetic field environment in the limited space inside the antenna. In particular, there is mutual interference between signals of different frequency bands, resulting in a distortion of the radiation pattern of the radiating elements operating in each frequency band, which may degrade the overall performance of the antenna.

The present disclosure provides a radiating element, which is capable of being “cloaked” to radiation in a frequency range different from the operating frequency range of the radiating element (“being cloaked” means that the radiating element has no effect or has significantly reduced effect on radiation in a frequency range different from the operating frequency range of the radiating element). Therefore, when such a radiating element and a radiating element operating in another frequency band are together in a narrow internal space of the antenna, the radiating element will not affect or has little effect on the performance of the radiating element operating in the other frequency band.

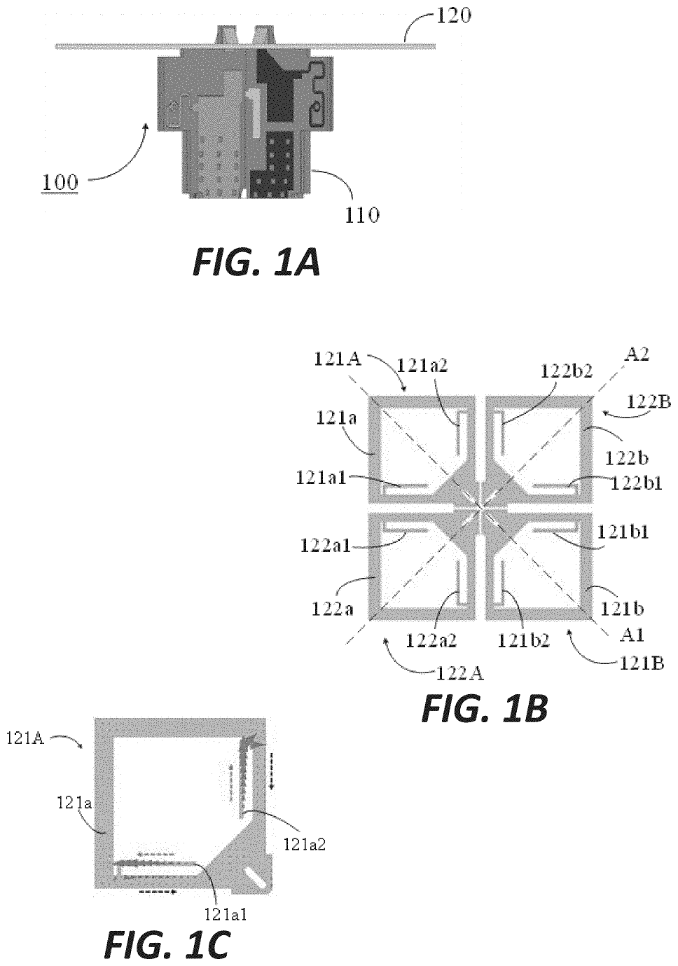

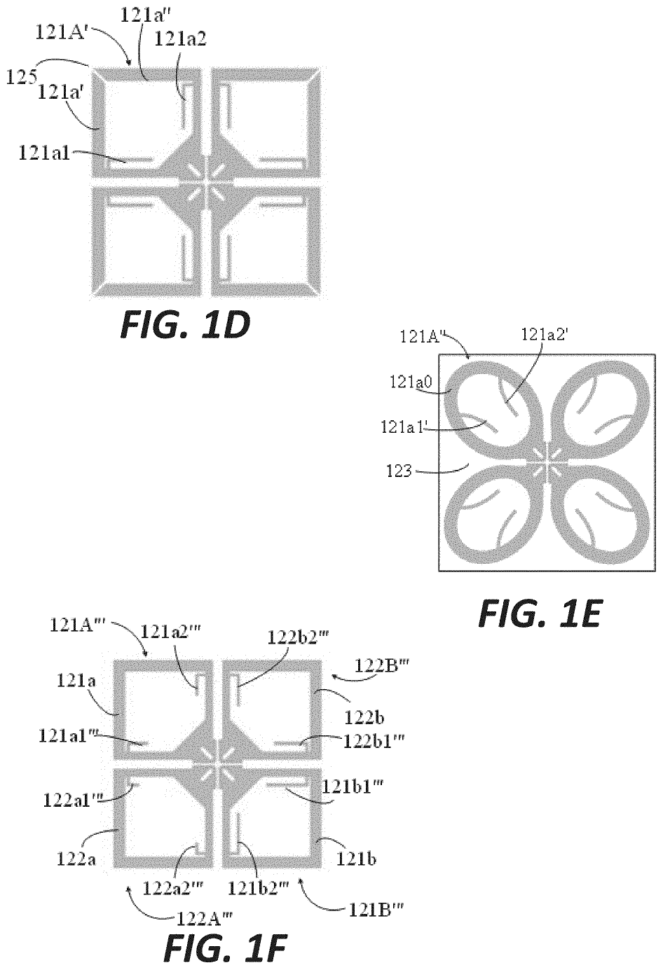

FIG. 1A and FIG. 1B show a radiating element 100 according to some embodiments of the present disclosure. As shown in FIG. 1A, the radiating element 100 may include a feed stalk 110 and a radiator 120 mounted on the feed stalk 110. As shown in FIG. 1B, the radiator 120 may include a first dipole arranged along a first axis A1 and including a first dipole arm 121A and a second dipole arm 121B, and a second dipole arranged along a second axis A2 substantially perpendicular to the first axis A1 and including a third dipole arm 122A and a fourth dipole arm 122B. The radiator 120 may be a cross dipole radiator. As used herein, “substantially perpendicular” means that the angle between the two is from 70° to 110°, preferably from 80° to 100°, more preferably from 85° to 95°, and is most preferably 90°.

Each of the first dipole arm to the fourth dipole arm may include a trunk conductive segment and a branch conductive segment at one end of which connected to the trunk conductive segment and at the other end of which being open. The trunk conductive segment and the branch conductive segment may be, for example, formed of any suitable conductive material such as metal. As shown in FIG. 1B, the first dipole arm 121A includes a trunk conductive segment 121a and branch conductive segments 121a 1 and 121a2, wherein one end of each of the branch conductive segments 121a1 and 121a2 is connected to the trunk conductive segment 121a and the other end remains open. The second dipole arm 121B includes a trunk conductive segment 121b and branch conductive segments 121b1 and 121b2, wherein one end of each of the branch conductive segments 121b1 and 121b2 is connected to the trunk conductive segment 121b and the other end remains open. The third dipole arm 122A includes a trunk conductive segment 122a and branch conductive segments 122a1 and 122a2, wherein one end of each of the branch conductive segments 122a1 and 122a2 is connected to the trunk conductive segment 122a and the other end remains open. The fourth dipole arm 122B includes a trunk conductive segment 122b and branch conductive segments 122b1 and 122b2, wherein one end of each of the branch conductive segments 122b1 and 122b2 is connected to the trunk conductive segment 122b and the other end remains open.

Each branch conductive segment may be configured such that a current induced by radiation in a preselected frequency range higher than the operating frequency range of the radiating element 100 in a portion, to which the branch conductive segment is connected, of the trunk conductive segment of the dipole arm is opposite to a current induced in the branch conductive segment. In the Specification, the currents opposite to each other may mean that the angle between the directions of the two currents is equal to 180° or an obtuse angle. For example, the angle between the directions of the two currents may be 180°±45°, preferably 180°±30°, more preferably 180°±15°, furthermore preferably 180°±5°.

Referring to FIG. 1C, the first dipole arm 121A is used as an example for description. When radiation in a preselected frequency range that is higher than the operating frequency range of the radiating element 100 is incident on the first dipole arm 121A, a current induced by the radiation in the preselected higher frequency band in a portion, to which the branch conductive segment 121a1 is connected, of the trunk conductive segment 121a of the first dipole arm 121A is opposite to a current induced in the branch conductive segment 121a1, and a current induced by the radiation in the preselected higher frequency band in a portion, to which the branch conductive segment 121a2 is connected, of the trunk conductive segment 121a of the first dipole arm 121A is opposite to a current induced in the branch conductive segment 121a2. The branch conductive segments 121a1 and 121a2 are respectively close to the portions of the trunk conductive segment 121a to which the branch conductive segments 121a1 and 121a2 are connected. Therefore, when scattering occurs, the energy scattered by the branch conductive segment and the portion of the trunk conductive segment to which the branch conductive segment is connected exhibits a cancelling effect. As a result, in general, the radiating element 100 behaves as if there is little or no radiation in the preselected higher frequency band, thereby reducing or even eliminating the effect on the radiation in the higher frequency band.

In some embodiments, branch conductive segments may be connected to the respective trunk conductive segments 121a, 121b, 122a, and 122b of each of the first dipole arm to the fourth dipole arm 121A, 121B, 122A, and 122B at respective positions at which the current induced in the trunk conductive segment of the dipole arm by the radiation in the preselected frequency range higher than the operating frequency range of the radiating element 100 reaches a maximum value. The current induced in the trunk conductive segment of the dipole arm by the radiation in the preselected frequency range higher than the operating frequency range of the radiating element 100 may have one or more maximum values, and the branch conductive segment(s) may be connected at one or more of one or more positions of the trunk conductive segment of the dipole arm corresponding to the one or more maximum values. In some examples, the branch conductive segment may be connected at a position of the trunk conductive segment of the dipole arm corresponding to the largest maximum value of the one or more maximum values.

In some embodiments, the trunk conductive segment of each of the first dipole arm to the fourth dipole arm 121A, 121B, 122A, and 122B may comprise a single closed conductive segment (e.g., as shown by FIG. 1B, FIG. 1E, etc.). In some embodiments, the closed conductive segment may be annular. In some embodiments, the trunk conductive segment of each of the first dipole arm to the fourth dipole arm 121A, 121B, 122A, and 122B may be in or substantially be in a square annular shape, e.g., as shown in FIG. 1B. Of course, the trunk conductive segment may also have other suitable shapes, which are not particularly limited herein. In some embodiments, the trunk conductive segment of each of the first dipole arm to the fourth dipole arm 121A, 121B, 122A, and 122B may be in or substantially be in an oval annular shape, for example, as shown in FIG. 1E. In FIG. 1E, the first dipole arm 121A″ is used as an example for description, the trunk conductive segment 121a0 of the first dipole arm 121A″ may be a single closed, oval annular, conductive segment, and in addition, FIG. 1E is different from FIG. 1B further in that the branch conductive segments 121a1′ and 121a2′ of the first dipole arm 121A″ have arc shapes. Note that, although the branch conductive segments are illustrated in most of the drawings as being parallel or substantially parallel to the adjacent trunk conductive segment portion, this is only exemplary and not restrictive. It can be understood that the branch conductive segment may also form a certain angle or a varying angle with respect to the adjacent trunk conductive segment portion, or may also be in, in addition to a linear shape, a shape of a polygonal line or a curve (such as the arc shape in FIG. 1E), as long as the branch conductive segment can be configured such that the current induced by radiation in the preselected frequency range higher than the operating frequency range of the radiating element 100 in the portion of the branch conductive segment to which the branch conductive segment is connected is opposite to the current induced in the branch conductive segment.

It also should be noted that, although the trunk conductive segments are illustrated in most of the drawings as being closed conductive segments, this is only exemplary and not restrictive. In some embodiments, the trunk conductive segment of each of the first dipole arm to the fourth dipole arm may comprise a first conductive segment and a second conductive segment which are connected to each other at their first ends proximal to the feed stalk and separated by a gap at their second ends opposite to the first ends. For example, as shown in FIG. 1D, the first dipole arm 121A′ is used as an example for description, the trunk conductive segment of the first dipole arm 121A′ comprises a first conductive segment 121a′ and a second conductive segment 121a″, the branch conductive segment 121a1 connects to the first conductive segment 121a′ at its one end and is open at its another end, the branch conductive segment 121a2 connects to the second conductive segment 121a″ at its one end and is open at its another end, the first conductive segment 121a′ and the second conductive segment 121a″ are connected to each other at their first ends proximal to the feed stalk and separated from each other by a gap 125 at their second ends opposite to the first ends. In some embodiments, the first conductive segment and the second conductive segment of the trunk conductive segment of each of the first dipole arm to the fourth dipole arm may collectively define an annular shape such as a square annular shape (as shown in FIG. 1D) or an oval annular shape or the like.

In some embodiments, the trunk conductive segment of each of the first dipole arm 121A and the second dipole arm 121B may be symmetrical about the first axis or substantially symmetrical about the first axis, and the trunk conductive segment of each of the third dipole arm 122A and the fourth dipole arm 122B may be symmetrical about the second axis or substantially symmetrical about the second axis. In some embodiments, the trunk conductive segments of the first dipole arm to the fourth dipole arm 121A, 121B, 122A, and 122B may be rotationally symmetrical or substantially rotationally symmetrical about an intersection of the first axis and the second axis. The symmetry can be advantageous to the radiation pattern of the radiating element 100 which uses these trunk conductive segments as dipole arms.

In some embodiments, each of the first dipole arm 121A and the second dipole arm 121B may have a length on the first axis A1 between 0.6 times to 0.7 times a wavelength corresponding to a center frequency of the operating frequency range of the radiating element 100, and/or each of the third dipole arm 122A and the fourth dipole arm 122B may have a length on the second axis A2 between 0.6 times to 0.7 times the wavelength corresponding to the center frequency of the operating frequency range of the radiating element 100. In some embodiments, each of the first dipole arm 121A and the second dipole arm 121B may have an electrical length which is about three quarters of the wavelength corresponding to the center frequency of the operating frequency range of the radiating element 100, and/or each of the third dipole arm 122A and the fourth dipole arm 122B may have an electrical length which is about three quarters of the wavelength corresponding to the center frequency of the operating frequency range of the radiating element 100. In such case, the dipoles of the radiator 120 of the radiating element 100 may be high impedance dipoles which may have significantly reduced adverse influence on patterns of radiation within a frequency range lower than the operating frequency range of the radiating element 100, which may be due to the effectively suppressed common mode resonance phenomenon.

In addition, the length of the branch conductive segment of each of the first dipole arm to the fourth dipole arm 121A, 121B, 122A, and 122B may be associated with a wavelength corresponding to a center frequency of the preselected frequency range to which the radiating element 100 is desired to be cloaked. Generally, the longer the branch conductive segment is, the lower the frequency range permitted to pass. In some embodiments, the branch conductive segment of each of the first dipole arm to the fourth dipole arm 121A, 121B, 122A, and 122B has a length between about one-eighth to about a quarter of the wavelength corresponding to the center frequency of the preselected frequency range higher than the operating frequency range of the radiating element 100. The term “about” herein may mean equal to the value described by the term or within ±20% of the value described by the term, preferably within ±10%, more preferably within ±5%, most preferably within ±1%. Such a branch conductive segment can cancel the effect of an adjacent trunk conductive segment portion on radiation of a higher frequency band.

In some embodiments, the branch conductive segment of at least one of the first dipole arm to the fourth dipole arm 121A, 121B, 122A, 122B may be configured such that a current induced by radiation in a preselected first frequency range higher than the operating frequency range of the radiating element in a portion, to which the branch conductive segment is connected, of the trunk conductive segment of the dipole arm is opposite to a current induced in the branch conductive segment, and the branch conductive segment of at least another one of the first dipole arm to the fourth dipole arm 121A, 121B, 122A, 122B may be configured such that a current induced by radiation in a preselected second frequency range higher than the operating frequency range of the radiating element in a portion, to which the branch conductive segment is connected, of the trunk conductive segment of the dipole arm is opposite to a current induced in the branch conductive segment, wherein the first frequency range may be higher than the second frequency range. In some examples, the branch conductive segment of the at least one of the first dipole arm to the fourth dipole arm 121A, 121B, 122A, 122B that is configured for the first frequency range may have a length shorter than that of the branch conductive segment of the at least another one of the first dipole arm to the fourth dipole arm 121A, 121B, 122A, 122B that is configured for the second frequency range. In some embodiments, the branch conductive segment of each of the first dipole arm to the fourth dipole arm 121A, 121B, 122A, 122B may be configured such that a current induced by radiation in a respective one of a preselected plurality of frequency ranges higher than the operating frequency range of the radiating element in a portion, to which the branch conductive segment is connected, of the trunk conductive segment of the dipole arm is opposite to a current induced in the branch conductive segment, the respective ones of the plurality of frequency ranges may be different from each other.

For example, as shown by FIG. 1F, the first dipole arm 121A′ comprises a trunk conductive segment 121a and branch conductive segments 121a1′″ and 121a2′″, the second dipole arm 121B′″ comprises a trunk conductive segment 121b and branch conductive segments 121b 1′″ and 121b2′″, the third dipole arm 122A′″ comprises a trunk conductive segment 122a and branch conductive segments 122a1′ and 122a2′″, the fourth dipole arm 122B′″ comprises a trunk conductive segment 122b and branch conductive segments 122b1′″ and 122b2′″. The branch conductive segments 121a1′″ and 121a2′″ of the first dipole arm 121A′ may be configured such that a current induced by radiation in a preselected second frequency range higher than the operating frequency range of the radiating element 100 in a portion, to which the branch conductive segment 121a1″, 121a2′″ is connected, of the trunk conductive segment 121a of the first dipole arm 121A′″ is opposite to a current induced in the branch conductive segments 121a1′″, 121a2″, the branch conductive segments 121b1′″ and 121b2′″ of the second dipole arm 121B′″ may be configured such that a current induced by radiation in a preselected fourth frequency range higher than the operating frequency range of the radiating element 100 in a portion, to which the branch conductive segment 121b1′″, 121b2′″ is connected, of the trunk conductive segment 121b of the second dipole arm 121B′″ is opposite to a current induced in the branch conductive segments 121b1′″, 121b2″, the branch conductive segments 122a1′″ and 122a2′″ of the third dipole arm 122A′″ may be configured such that a current induced by radiation in a preselected first frequency range higher than the operating frequency range of the radiating element 100 in a portion, to which the branch conductive segment 122a1″ 122a2′″ is connected, of the trunk conductive segment 122a of the third dipole arm 122A′″ is opposite to a current induced in the branch conductive segments 122a1″ 122a2″, the branch conductive segments 122b1′″ and 122b2″′ of the fourth dipole arm 122B′″ may be configured such that a current induced by radiation in a preselected third frequency range higher than the operating frequency range of the radiating element 100 in a portion, to which the branch conductive segment 122b1″ 122b2′″ is connected, of the trunk conductive segment 122b of the fourth dipole arm 122B′″ is opposite to a current induced in the branch conductive segments 122b1″ 122b2″. The first frequency range may be higher than the second frequency range, the second frequency range may be higher than the third frequency range, the third frequency range may be higher than the fourth frequency range. The lengths of the branch conductive segments 122a1′″, 122a2″ of the third dipole arm 122A′″ may be shorter than the lengths of the branch conductive segments 121a1′″, 121a2″ of the first dipole arm 121A′″, the lengths of the branch conductive segments 121a1′″, 121a2″ of the first dipole arm 121A′″ may be shorter than the lengths of the branch conductive segments 122b1″ 122b2″ of the fourth dipole arm 122B′″, the lengths of the branch conductive segments 122b1″ 122b2″ of the fourth dipole arm 122B″ may be shorter than the lengths of the branch conductive segments 121b1′″, 121b2″ of the second dipole arm 121B″.

Each of the first dipole arm to the fourth dipole arm 121A, 121B, 122A, and 122B may include one or more branch conductive segments. In some embodiments, the number of branch conductive segments included in each of the first dipole arm to the fourth dipole arm 121A, 121B, 122A, and 122B may be an even number. In some embodiments, the branch conductive segments of each of the first dipole arm 121A and the second dipole arm 121B may be arranged symmetrically about the first axis or may be arranged substantially symmetrically about the first axis, and the branch conductive segments of each of the third dipole arm 122A and the fourth dipole arm 122B may be arranged symmetrically about the second axis or may be arranged substantially symmetrically about the second axis. In some embodiments, the first dipole arm to the fourth dipole arm 121A, 121B, 122A, and 122B may be rotationally symmetrical or substantially rotationally symmetrical about the intersection of the first axis and the second axis. The symmetry of the arrangement of the branch conductive segments is advantageous to prevent the radiation pattern of the radiating element 100, which uses a trunk conductive segment to which the branch conductive segment is connected as a dipole, from being adversely affected by the addition of the branch conductive segments.

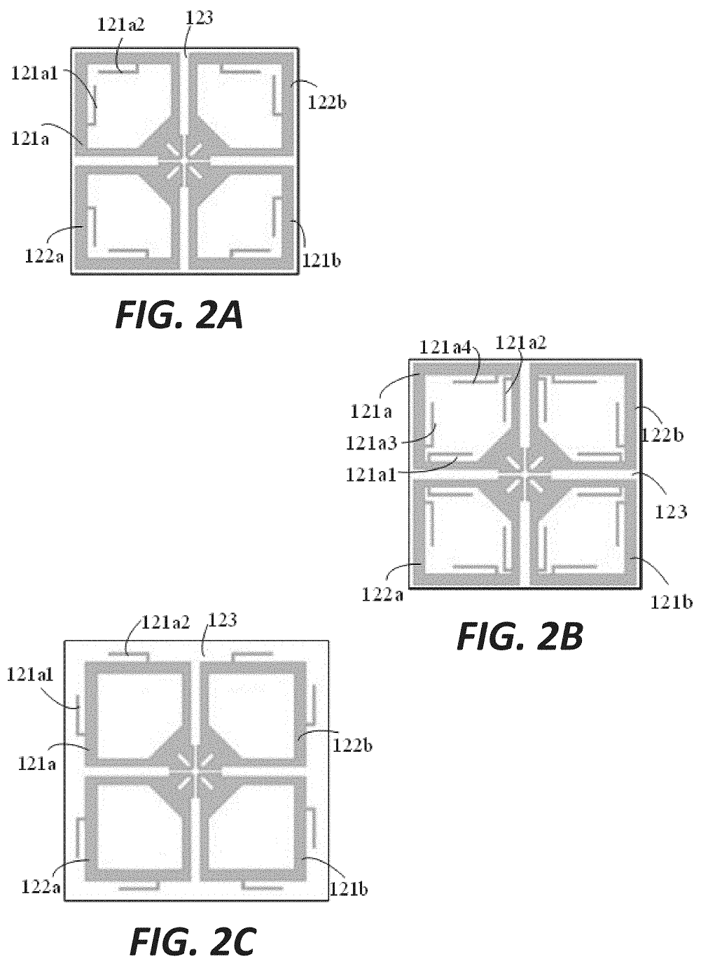

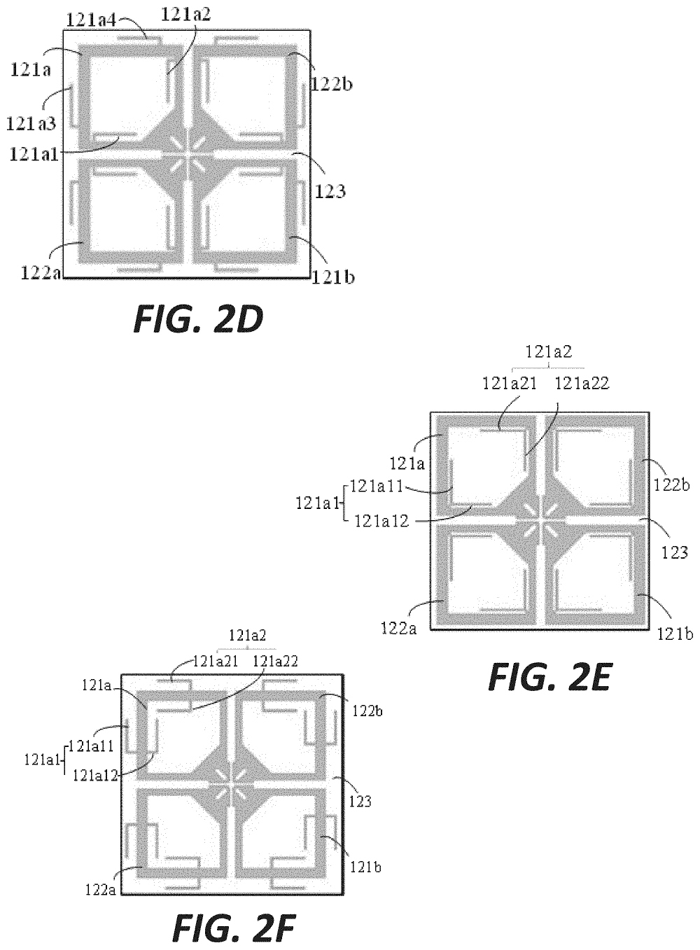

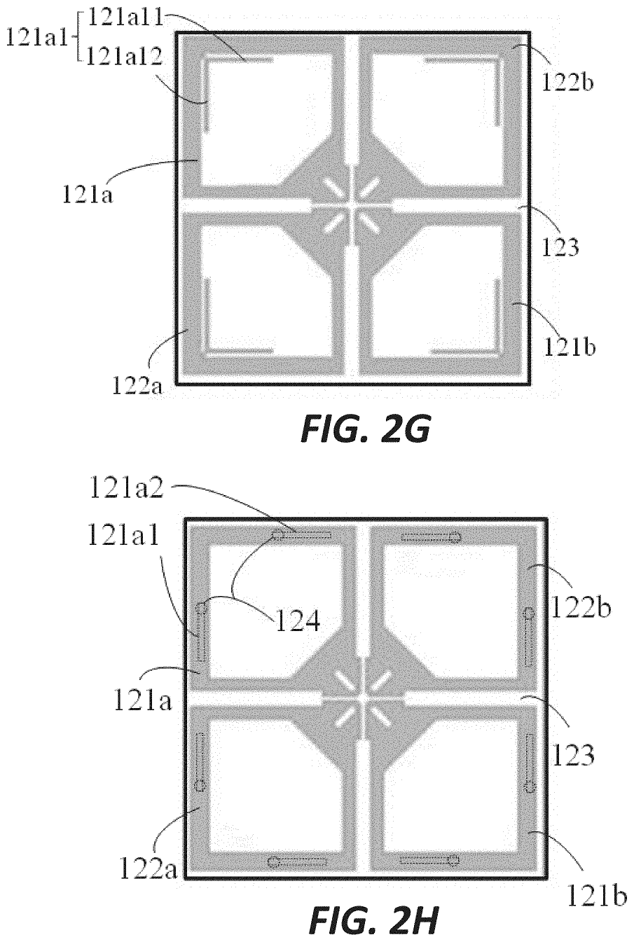

In the present disclosure, the dipoles of the radiating element 100 may adopt any appropriate form. In some embodiments, the first dipole and the second dipole of the radiator 120 of the radiating element 100 may be sheet metal dipoles. For example, the trunk conductive segment and the branch conductive segment of the radiating element 100 may be cut from a stamped sheet metal. The trunk conductive segment and the branch conductive segment may be formed integrally, or may be separate parts that are physically and electrically connected together by welding, via conductive connecting member(s), or in other suitable manner. In some embodiments, the radiator 120 of the radiating element 100 may further include a dielectric substrate on which the trunk conductive segment and the branch conductive segment may be disposed. For example, FIG. 1E and FIGS. 2A to 2H that will be described later show a dielectric substrate 123. As an non-limiting example, in cases where the radiator 120 comprises a dielectric substrate 123, the trunk conductive segment and the branch conductive segment may be metal traces formed on the dielectric substrate 123, or may be sheet metal adhered or otherwise fixed to the dielectric substrate 123, or the like.

FIGS. 2A to 2H additionally show several exemplary arrangements of the branch conductive segments of the dipole arm of the radiating element 100. It will be appreciated that, although a radiator 120 including a dielectric substrate is used as an example for illustration in FIGS. 2A to 2H, these arrangements also apply to a radiator 120 without a dielectric substrate, for example, to a sheet metal dipole radiator.

In some embodiments, the branch conductive segments of each of the first dipole arm to the fourth dipole arm 121A, 121B, 122A, and 122B may be all arranged inside a boundary defined by the trunk conductive segment of the dipole arm. For example, as shown in FIG. 1B, FIG. 2A, and FIG. 2B, the branch conductive segments 121a1, 121a2, 121a3, and 121a4 are all arranged inside the boundary defined by the trunk conductive segment 121a. In some embodiments, the branch conductive segments of each of the first dipole arm to the fourth dipole arm 121A, 121B, 122A, and 122B may be all arranged outside the boundary defined by the trunk conductive segment of the dipole arm. For example, as shown in FIG. 2C, the branch conductive segments 121a1 and 121a2 are both arranged outside the boundary defined by the trunk conductive segment 121a. In some embodiments, some of the branch conductive segments of each of the first dipole arm to the fourth dipole arm 121A, 121B, 122A, and 122B may be arranged outside the boundary defined by the trunk conductive segment of the dipole arm, while the other may be arranged inside the boundary defined by the trunk conductive segment of the dipole arm. For example, as shown in FIG. 2D, the branch conductive segments 121a3 and 121a4 are arranged outside the boundary defined by the trunk conductive segment 121a, while the branch conductive segments 121a1 and 121a2 are arranged inside the boundary defined by the trunk conductive segment 121a. In addition, the branch conductive segment may be neither inside the boundary defined by the trunk conductive segment nor outside the boundary defined by the trunk conductive segment. In some embodiments, the branch conductive segment of at least one of the first dipole arm to the fourth dipole arm overlaps with the trunk conductive segment of the dipole arm in length direction thereof. For example, as shown in FIG. 2H, the trunk conductive segment 121a is located at a first surface (the illustrated surface) of the dielectric substrate 123, the branch conductive segments 121a1 and 121a2 are located at a second surface of the dielectric substrate 123 opposite to the first surface (dash lines indicate that they are located at a surface opposite to the illustrated surface), the branch conductive segments 121a1 and 121a2 may be connected to the trunk conductive segment 121a via respective conductive connecting members 124 (such as through holes at least partially filled with a conductive material), and the branch conductive segments 121a1 and 121a2 overlap with the trunk conductive segment 121a at length directions thereof.

In some embodiments, the branch conductive segment of each of the first dipole arm to the fourth dipole arm 121A, 121B, 122A, and 122B may include a first sub-branch conductive segment and a second sub-branch conductive segment, the first sub-branch conductive segment and the second sub-branch conductive segment may be connected to the trunk conductive segment of the dipole arm at the same position, and wherein: the first sub-branch conductive segment is arranged inside the boundary defined by the trunk conductive segment of the dipole arm and the second sub-branch conductive segment is arranged outside the boundary defined by the trunk conductive segment of the dipole arm, or the first sub-branch conductive segment and the second sub-branch conductive segment are both arranged outside the boundary defined by the trunk conductive segment of the dipole arm, or the first sub-branch conductive segment and the second sub-branch conductive segment are both arranged inside the boundary defined by the trunk conductive segment of the dipole arm, or the first sub-branch conductive segment is arranged inside or outside the boundary defined by the trunk conductive segment of the dipole arm and the second sub-branch conductive segment overlaps with the trunk conductive segment of the dipole arm in length direction thereof. For example, as shown in FIG. 2E, the branch conductive segment 121a1 includes a first sub-branch conductive segment 121a11 and a second sub-branch conductive segment 121a12, and the branch conductive segment 121a2 includes a first sub-branch conductive segment 121a21 and a second sub-branch conductive segment 121a22, wherein the first sub-branch conductive segment 121a11 and the second sub-branch conductive segment 121a12, and the first sub-branch conductive segment 121a21 and the second sub-branch conductive segment 121a22 are all arranged inside the boundary defined by the trunk conductive segment 121a. For example, as shown in FIG. 2F, the branch conductive segment 121a1 includes a first sub-branch conductive segment 121a11 and a second sub-branch conductive segment 121a12, and the branch conductive segment 121a2 includes a first sub-branch conductive segment 121a21 and a second sub-branch conductive segment 121a22, wherein the first sub-branch conductive segment 121a11 and the first sub-branch conductive segment 121a21 are arranged outside the boundary defined by the trunk conductive segment 121a, while the second sub-branch conductive segment 121a12 and the second sub-branch conductive segment 121a22 are arranged inside the boundary defined by the trunk conductive segment 121a. In FIG. 2G, only one branch conductive segment 121a1 is connected to the trunk conductive segment 121a, the branch conductive segment 121a1 includes a first sub-branch conductive segment 121a11 and a second sub-branch conductive segment 121a12, and the first sub-branch conductive segment 121a11 and the second sub-branch conductive segment 121a12 are arranged symmetrically about the first axis.

The above-described arrangements of the branch conductive segments are merely exemplary and not restrictive. The branch conductive segments may be specifically arranged on the trunk conductive segment according to the operating frequency range of the radiator 120 and the frequency range to which the radiating element 100 needs to be cloaked.

In addition, although the branch conductive segments and the trunk conductive segments are illustrated as being on a same surface of the dielectric substrate 123 in most of FIGS. 2A to 2H, this is only exemplary and not restrictive. In some other embodiments, the branch conductive segment and the trunk conductive segment may be respectively arranged on different surfaces of the dielectric substrate. In such cases, the branch conductive segment and the trunk conductive segment may be electrically connected to each other through, for example, a through hole that penetrates the dielectric substrate and is at least partially filled with a conductive material (e.g., as shown in FIG. 2H). In some other embodiments, the dielectric substrate may be a multilayer dielectric substrate, and the trunk conductive segment and the branch conductive segment may be arranged on a same layer or different layers of the multilayer dielectric substrate. In embodiments in which the trunk conductive segment and the branch conductive segment are arranged on different layers of the multilayer dielectric substrate, the trunk conductive segment and the branch conductive segment may be electrically connected to each other through, for example, a through hole that penetrates the corresponding layer of the dielectric substrate and is at least partially filled with a conductive material. When each trunk conductive segment is connected with a plurality of branch conductive segments, each of the plurality of branch conductive segments does not necessarily have to be on the same surface of the dielectric substrate or on the same layer of the multilayer dielectric substrate, but may be distributed on different surfaces of the dielectric substrate or on different layers of the multilayer dielectric substrate through, for example, a through hole at least partially filled with a conductive material. In some embodiments, a distribution of the plurality of branch conductive segments of the first dipole arm on different surfaces of the dielectric substrate or on different layers of the dielectric substrate that is a multilayer dielectric substrate and a distribution of the plurality of branch conductive segments of the second dipole arm on different surfaces of the dielectric substrate or on different layers of the dielectric substrate that is a multilayer dielectric substrate may be symmetrical about the second axis A2 or may be substantially symmetrical about the second axis A2, and/or a distribution of the plurality of branch conductive segments of the third dipole arm on different surfaces of the dielectric substrate or on different layers of the dielectric substrate that is a multilayer dielectric substrate and a distribution of the plurality of branch conductive segments of the fourth dipole arm on different surfaces of the dielectric substrate or on different layers of the dielectric substrate that is a multilayer dielectric substrate may be symmetrical about the first axis A1 or may be substantially symmetrical about the first axis A1.

In addition, although the trunk conductive segments are illustrated as being on one surface of the dielectric substrate 123 in FIGS. 2A to 2H, but this is merely exemplary and not restrictive. In some embodiments, the trunk conductive segment may include a plurality of portions disposed on a same surface of the dielectric substrate. The plurality of portions of the trunk conductive segment is electrically connected to each other. In some other embodiments, the trunk conductive segment may include a plurality of portions disposed on different surfaces of the dielectric substrate. The plurality of portions of the trunk conductive segment may be electrically connected to each other through, for example, a through hole that penetrates the dielectric substrate and is at least partially filled with a conductive material. In some other embodiments, the dielectric substrate may be a multilayer dielectric substrate, and the trunk conductive segment may include a plurality of portions disposed on a same layer or different layers of the multilayer dielectric substrate. In embodiments in which the trunk conductive segment includes a plurality of portions disposed on different layers of the multilayer dielectric substrate, the plurality of portions of the trunk conductive segment may be electrically connected to each other through, for example, a through hole that penetrates the respective layer of the dielectric substrate and is at least partially filled with a conductive material. In some embodiments, a distribution of the plurality of portions of the trunk conductive segment of the first dipole arm on different surfaces of the dielectric substrate or on different layers of the dielectric substrate that is a multilayer dielectric substrate and a distribution of the plurality of portions of the trunk conductive segment of the second dipole arm on different surfaces of the dielectric substrate or on different layers of the dielectric substrate that is a multilayer dielectric substrate may be symmetrical about the second axis A2 or may be substantially symmetrical about the second axis A2, and/or a distribution of the plurality of portions of the trunk conductive segment of the third dipole arm on different surfaces of the dielectric substrate or on different layers of the dielectric substrate that is a multilayer dielectric substrate and a distribution of the plurality of portions of the trunk conductive segment of the fourth dipole arm on different surfaces of the dielectric substrate or on different layers of the dielectric substrate that is a multilayer dielectric substrate may be symmetrical about the first axis A1 or may be substantially symmetrical about the first axis A1.

It will also be appreciated that, for embodiments of sheet metal dipole radiators, for example, the trunk conductive segment and the branch conductive segment may not necessarily be located in a same plane, and if the trunk conductive segment comprises a plurality of portions, the plurality of portions of the trunk conductive segment may not necessarily be located in a same plane.

Adding the branch conductive segment to the dipole arm of the radiating element can be helpful in making the radiating element cloaked to the desired frequency range, and adding the branch conductive segment to the dipole arm of the radiating element in a symmetrical manner about the axis of the dipole arm of the radiating element can further make the radiating element cloaked to the desired frequency range with its own radiation performance unaffected. The radiating element according to the present disclosure may be advantageous to form a multi-band antenna together with radiating elements operating in other operating frequency ranges without affecting or having little effect on the performance of the radiating elements operating in other operating frequency ranges.

The present disclosure further provides a multi-band base station antenna, which may include the aforementioned radiating element, so that including radiating elements of different frequency bands in the multi-band base station antenna does not cause deterioration of antenna performance, especially radiation pattern.

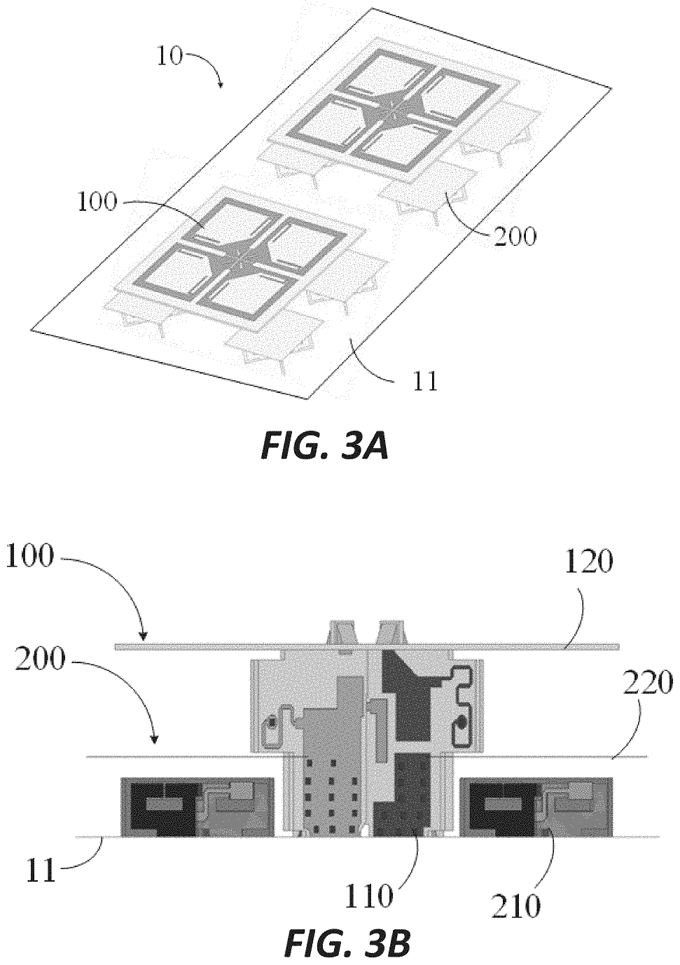

A multi-band base station antenna 10 according to some embodiments of the present disclosure will be described in detail with reference to FIGS. 3A and 3B. It should be noted that the actual base station antenna may also have other components, and in order to avoid obscuring the main points of the present disclosure, other components are not shown in the accompanying drawings and will not be discussed herein. It should also be noted that FIGS. 3A and 3B only schematically show the relative positional relationship of various components, and there is no particular limitation on the specific structure of each component. It will also be appreciated that the multi-band base station antenna 10 (as well as the other multi-band base station antennas depicted herein) may include more radiating elements than shown.

The multi-band base station antenna 10 may include a reflector 11, a first radiating element 100 mounted on the reflector 11, and a second radiating element 200 mounted on the reflector 11. The first radiating element 100 may be configured to operate in a first operating frequency range. The second radiating element 200 may be configured to operate in a second operating frequency range which is higher than the first operating frequency range. The first radiating element 100 may be the radiating element 100 according to any of the aforementioned embodiments of the present disclosure, and the branch conductive segment of each dipole arm of the first radiating element 100 may be configured such that a current induced by radiation in the second operating frequency range of the second radiating element 200 in a portion, to which the branch conductive segment is connected, of the trunk conductive segment of the dipole arm is opposite to a current induced in the branch conductive segment.

In order to miniaturize the multi-band base station antenna 10, the first radiating element and the second radiating element may be arranged more compactly. In some embodiments, as can be seen more clearly from FIG. 3B, a radiator 120 of the first radiating element 100 is farther from the reflector 11 than a radiator 220 of the second radiating element 200, and as can be seen more clearly in combination with FIG. 3A, when viewed from a direction perpendicular to the surface of the reflector 11, the radiator 120 of the first radiating element 100 covers at least a part of the radiator 220 of the second radiating element 200.

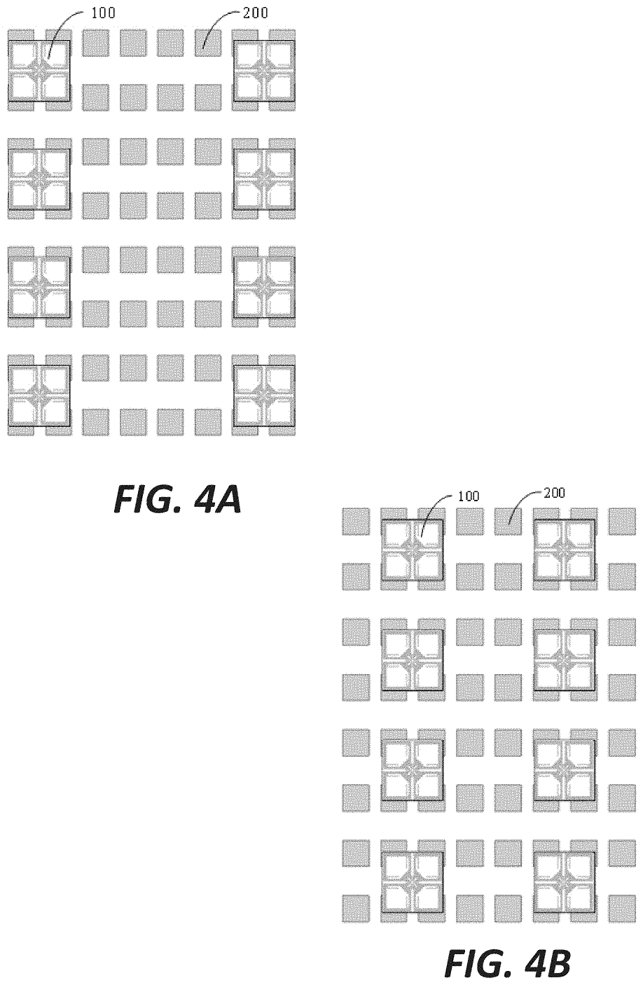

FIG. 4A and FIG. 4B show several exemplary compact layouts of the multi-band base station antenna 10. In some embodiments, the multi-band base station antenna 10 may include a plurality of first radiating elements 100 and a plurality of second radiating elements 200, which may be arranged such that, when viewed from a direction perpendicular to the surface of the reflector 11, each first radiating element 100 at least partially overlaps with one or more second radiating elements 200. In some examples, when viewed from a direction perpendicular to the surface of the reflector 11, each second radiating element 200 of the one or more second radiating elements 200 with which each first radiating element 100 at least partially overlaps is located below a corresponding dipole arm of the first radiating element 100. For example, FIG. 4A and FIG. 4B show a multi-band base station antenna 10 including two columns of first radiating elements 100 and eight columns of second radiating elements 200, where each first radiating element 100 at least partially overlaps with four second radiating elements 200, and the four second radiating elements 200 are respectively located below a corresponding dipole arm of the first radiating element 100.

In order to further reduce the effect on the second radiating element 200, in some embodiments in which the radiator of the first radiating element 100 includes a dielectric substrate, the dielectric substrate of the radiator of the first radiating element 100 may be at least partially hollowed out. The hollowing out of the dielectric substrate may be performed according to the contours of the trunk conductive segment and the branch conductive segment. Specifically, some or all of the portion of the dielectric substrate of the radiator of the first radiating element 100 that does not include the trunk conductive segment and the branch conductive segment may be removed (for example, removing the portion of the dielectric substrate inside the boundary defined by the trunk conductive segment where no branch conductive segments are provided), so that the portion of the dielectric substrate used as a support is retained, and the attenuation of signals radiated by the second radiating element 200 blocked by the first radiating element 100 is reduced as much as possible.

In a conventional multi-band base station antenna, when a radiator of a lower frequency band radiating element covers a radiator of a higher frequency band radiating element, it may cause serious distortion in the radiation pattern of the higher frequency band radiating element. This condition between a high-band (for example, 3.3 GHz to 4.2 GHz or a part thereof) radiating element and a mid-band (for example, 1.7 GHz to 2.7 GHz or a part thereof) is even worse than that between a mid-band (for example, 1.7 GHz to 2.7 GHz or a part thereof) radiating element and a low-band (for example, 617 MHz to 960 MHz or a part thereof) radiating element. Therefore, lower frequency band radiating elements are generally arranged outside an array of higher frequency band radiating elements, or the spacing between the radiating elements is increased to avoid as much as possible the higher frequency band radiating elements being covered by the lower frequency band radiating elements to result in the distortion of the radiation pattern. However, this usually increases the size of the antenna, and this situation becomes more severe when the number of radiating elements included in the antenna increases and the operating frequency bands of the antenna increase. In contrast, in the multi-band base station antenna 10 according to the present disclosure, since the existence of the first radiating element 100 does not have an effect or has little effect on the radiation in the second operating frequency range, the radiation pattern of the second radiating element 200 will not be significantly affected even if the radiator 120 of the first radiating element 100 covers at least a part of the radiator 220 of the second radiating element 200.

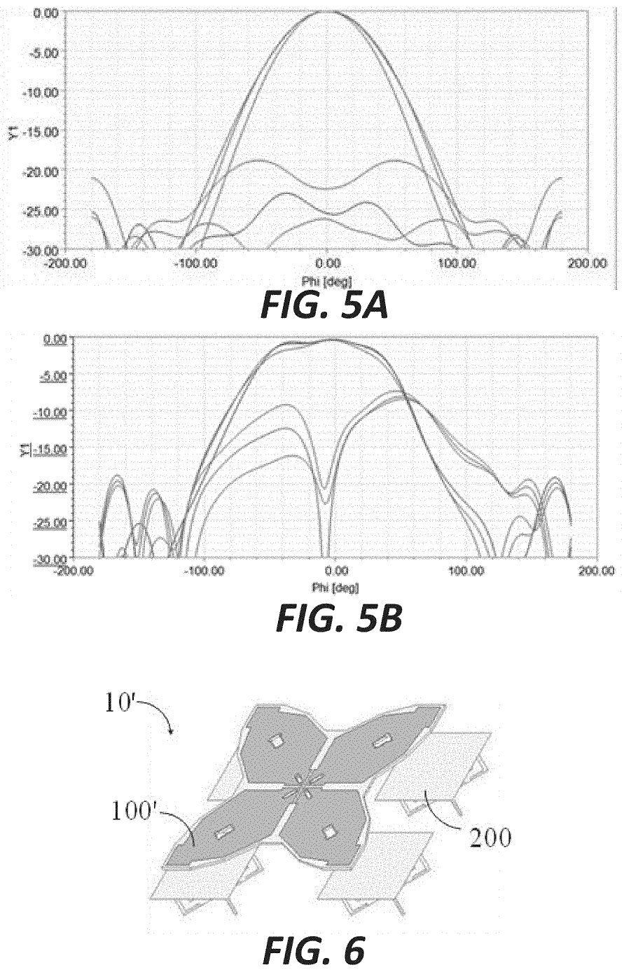

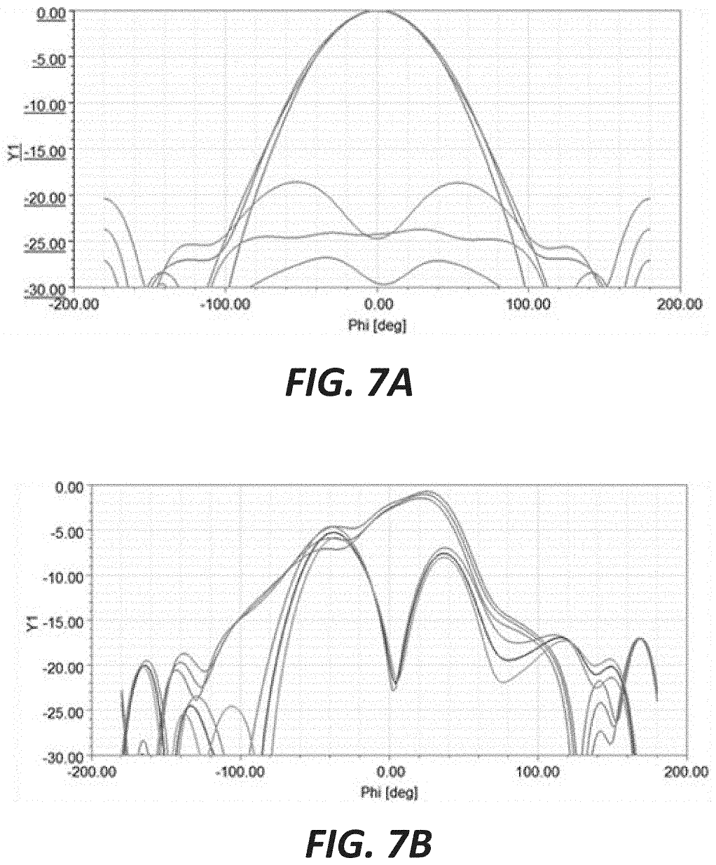

In order to show the excellent performance of the multi-band base station antenna 10 according to the present disclosure, FIG. 5A shows the radiation pattern of the first radiating element 100 (taking a mid-band radiating element as an example) of the multi-band base station antenna 10 according to the present disclosure at three operating frequency points, 1.7 GHz, 2.2 GHz, and 2.7 GHz, and FIG. 5B shows the radiation pattern of the second radiating element 200 (taking a high-band radiating element as an example) of the multi-band base station antenna 10 according to the present disclosure at three operating frequency points, 3.4 GHz, 3.5 GHz, and 3.6 GHz. In contrast, FIG. 6 shows a conventional multi-band base station antenna 10′, and the conventional multi-band base station antenna 10′ includes the same second radiating element 200 as the second radiating element 200 of the multi-band base station antenna 10. However, its first radiating element 100′ is a conventional cross dipole radiating element. FIG. 7A shows the radiation pattern of the first radiating element 100′ (taking a mid-band radiating element as an example) of the conventional multi-band base station antenna 10′ at three operating frequency points, 1.7 GHz, 2.2 GHz, and 2.7 GHz, and FIG. 7B shows the radiation pattern of the second radiating element 200 (taking a high-band radiating element as an example) of the conventional multi-band base station antenna 10′ at three operating frequency points, 3.4 GHz, 3.5 GHz, and 3.6 GHz. By comparing FIGS. 5A, 5B, 7A, and 7B, it can be seen that the radiation pattern of the second radiating element 200 of the conventional multi-band base station antenna 10′ is significantly distorted due to the effect of the first radiating element 100′, whereas the radiation pattern of the second radiating element 200 of the multi-band base station antenna 10 according to the present disclosure is slightly affected by the first radiating element 100 or hardly affected by the first radiating element 100.

Since the existence of the first radiating element 100 in the multi-band base station antenna 10 according to the present disclosure does not affect or has little effect on the operation of the second radiating element 200, the arrangement of the first radiating element 100 and the arrangement of the second radiating element 200 can be freely considered separately without worrying that an overlapping layout of the two will affect the operating performance of each other. Therefore, the multi-band base station antenna 10 according to the present disclosure can maintain high performance while achieving high integration and miniaturization.

In addition, in order to alleviate or eliminate the effect of the second radiating element 200 of a higher frequency band on the operation of the first radiating element 100 of a lower frequency band, in some embodiments, the second radiating element 200 may be a patch dipole radiating element. As shown in FIG. 3B, the second radiating element 200 may be a low-profile patch dipole radiating element (for example, its height (or the distance between the radiator and the reflector) may be only 10 mm). The low-profile second radiating element 200 may, therefore, be farther away from the radiator of the first radiating element 100 than a conventional cross-dipole second radiating element would be, thereby alleviating the adverse effects caused by the overlap of the two. In addition, the second radiating element, which serves as a patch dipole radiating element, does not have a metal connection between its feed stalk 210 and the radiator 220, but can be mounted by, for example, a plastic member or the like so that the feed stalk 210 is capacitively couples to the radiator 220 across a gap. The gap between the feed stalk 210 and the radiator 220 (for example, the gap may be 3 mm to 5 mm) greatly weakens the effect of the second radiating element 200 of a higher frequency band on the radiation pattern of the first radiating element 100 of a lower frequency band.

The multi-band base station antenna 10 according to the present disclosure exemplarily includes radiating elements of two frequency bands. However, the present disclosure is not limited thereto, and may include more kinds of radiating elements of different frequency bands. In some embodiments, the multi-band base station antenna according to the present disclosure may further include a third radiating element mounted on the reflector, and the third radiating element may be configured to operate in a third operating frequency range which is lower than the first operating frequency range. In some embodiments, the third radiating element may be configured to be cloaked to radiation in the first operating frequency range of the first radiating element and/or the second operating frequency range of the second radiating element.

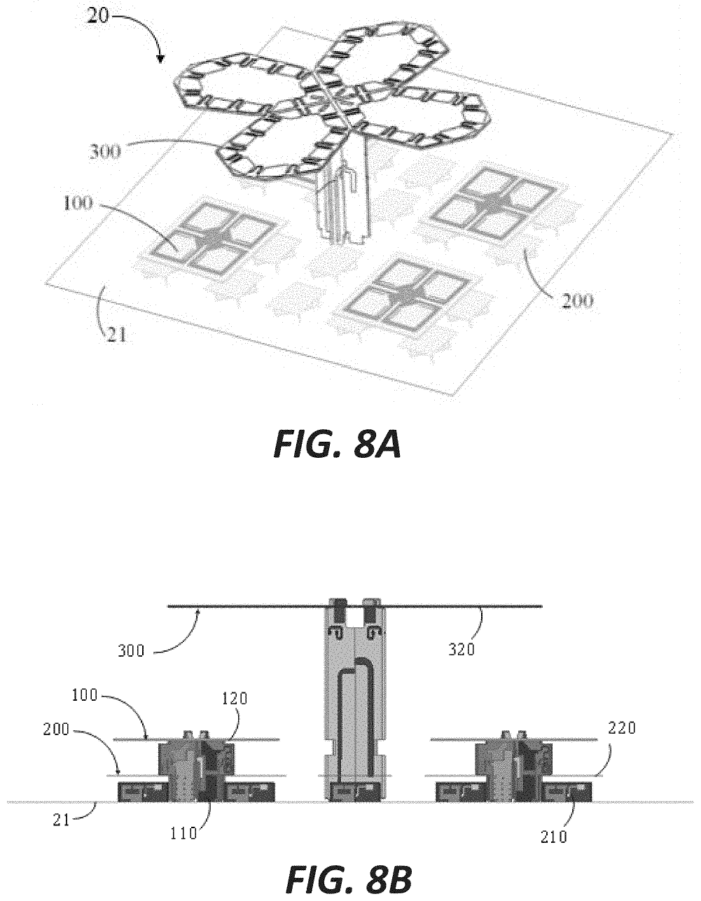

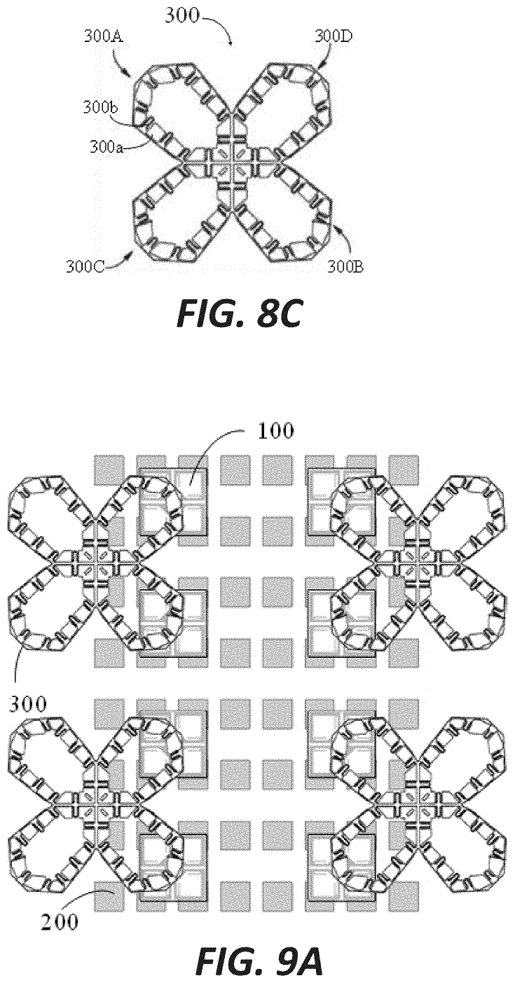

For example, FIG. 8A exemplarily shows a multi-band base station antenna 20 according to the present disclosure. The multi-band base station antenna 20 may include a reflector 21, a first radiating element 100 mounted on the reflector 21, a second radiating element 200 mounted on the reflector 21, and a third radiating element 300 mounted on the reflector 21. The first radiating element 100 may be configured to operate in a first operating frequency range (for example, a frequency range of 1.7 GHz to 2.7 GHz or a part thereof). The second radiating element 200 may be configured to operate in a second operating frequency range (for example, a frequency range of 3.3 GHz to 4.2 GHz or a part thereof) which is higher than the first operating frequency range. The third radiating element 300 may be configured to operate in a third operating frequency range (for example, a frequency range of 617 MHz to 960 MHz or a part thereof) which is lower than the first operating frequency range. The first radiating element 100 and the second radiating element 200 may be as described above. The branch conductive segment of each dipole arm of the first radiating element 100 may be configured such that a current induced by radiation in the second operating frequency range of the second radiating element 200 in a portion, to which the branch conductive segment is connected, of the trunk conductive segment of the dipole arm is opposite to a current induced in the branch conductive segment.

The third radiating element 300 may be configured to be cloaked to radiation in the first operating frequency range of the first radiating element 100 and/or the second operating frequency range of the second radiating element 200. In other words, the third radiating element 300 may be configured to allow radiation in the first operating frequency range of the first radiating element 100 and/or the second operating frequency range of the second radiating element 200 to pass substantially unaffected.

In some embodiments, as shown in FIG. 8C, the third radiating element 300 may include a cross dipole radiator, and each dipole arm, 300A, 300B, 300C, and 300D, of the cross dipole radiator may include a corresponding conductive segment and a corresponding inductor capacitor circuit. The inductor capacitor circuit may define a filter, which may be configured to allow radiation in the first operating frequency range of the first radiating element 100 and/or the second operating frequency range of the second radiating element 200 to pass. As shown in FIG. 8C, each of the dipole arms 300A, 300B, 300C, and 300D includes a widened conductive segment 300a and a narrowed conductive segment 300b. The narrowed conductive segment 300b may be regarded as an inductor, and the gap between the narrowed conductive segment 300b and the widened conductive segment 300a may be regarded as a capacitor. Desired equivalent inductance and equivalent capacitance are achieved by designing the specific shape and size of the widened conductive segment 300a and the narrowed conductive segment 300b, so that the filter defined by the formed inductor capacitor circuit achieves a desired frequency range which allows passage.

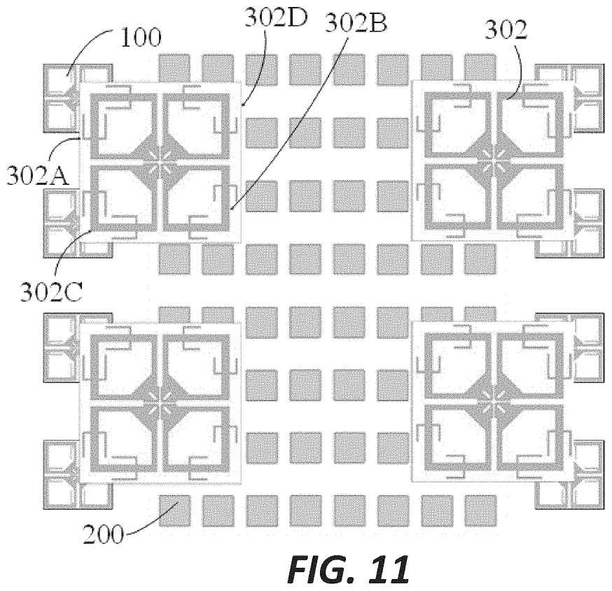

Of course, the example of the third radiating element is not limited to the third radiating element 300 shown in FIG. 8C. In some embodiments, as shown in FIG. 11, the third radiating element may be the radiating element 302 according to any of the aforementioned embodiments of the present disclosure, and the branch conductive segment of each dipole arm of the third radiating element 302 may be configured such that a current induced by radiation in the first operating frequency range of the first radiating element 100 and/or the second operating frequency range of the second radiating element 200 in a portion, to which the branch conductive segment is connected, of the trunk conductive segment of the dipole arm is opposite to a current induced in the branch conductive segment. In order to further reduce the effect on the first radiating element 100 and the second radiating element 200, in some embodiments in which the radiator of the third radiating element 302 includes a dielectric substrate, the dielectric substrate of the radiator of the third radiating element 302 may be at least partly hollowed out. The hollowing out of the dielectric substrate may be performed, for example, according to the contours of the trunk conductive segment and the branch conductive segment. Specifically, the portion of the dielectric substrate of the radiator of the third radiating element 302 that does not include the trunk conductive segment and the branch conductive segment may be partially or fully removed (for example, removing the portion of the dielectric substrate inside the boundary defined by the trunk conductive segment where no branch conductive segments are provided), so that the portion of the dielectric substrate used as a support is retained, and the attenuation of signals radiated by the first radiating element 100 and the second radiating element 200 blocked by the third radiating element 302 is reduced as much as possible.

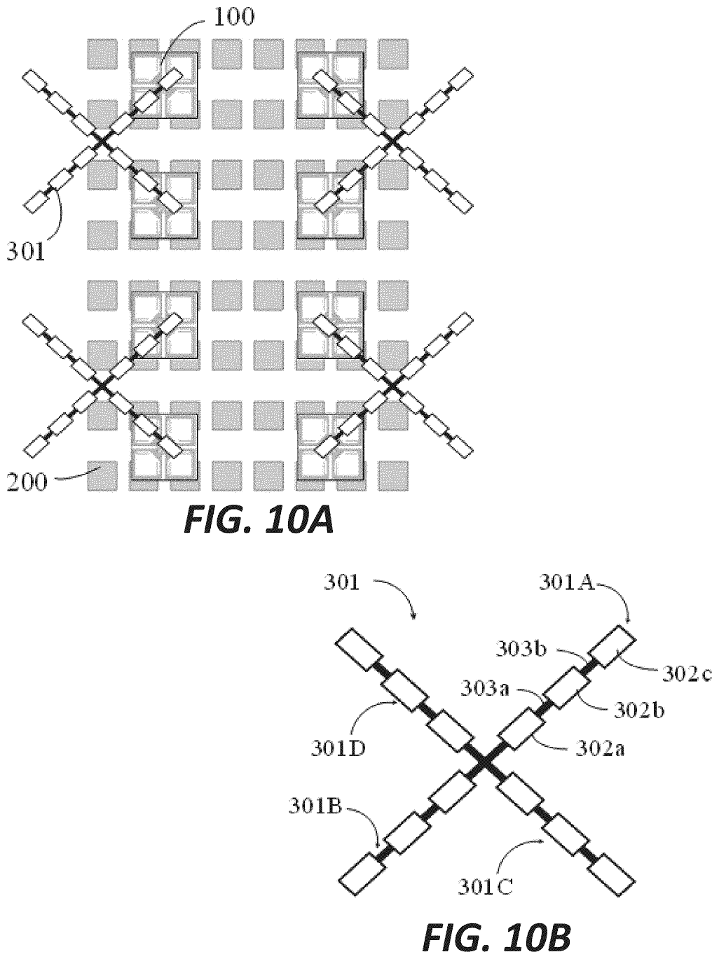

In some other embodiments, as shown in FIG. 10A and FIG. 10B, the third radiating element 301 includes a cross dipole radiator, and each dipole arm, 301A, 301B, 301C, and 301D, of the cross dipole radiator includes a plurality of dipole segments 302a, 302b, and 302c, and chokes 303a and 303b arranged between adjacent dipole segments of these dipole segments. The chokes are configured to minimize the effect of current induced in the dipole arm of the third radiating element 301 by radiation in the first operating frequency range of the first radiating element 100 and/or the second operating frequency range of the second radiating element 200. By using the choke characteristics, it is possible to improve the cloaking performance of the third radiating element 301 to radiation in the first operating frequency range of the first radiating element 100 and/or the second operating frequency range of the second radiating element 200, so that the third radiating element 301 does not affect or has little effect on the radiation patterns of the first radiating element 100 and/or the second radiating element 200.

In order to miniaturize the multi-band base station antenna 20, the first radiating element, the second radiating element, and the third radiating element may be arranged more compactly. In some embodiments, as can be seen more clearly from FIG. 8B, a radiator 320 of the third radiating element 300 is farther from the reflector 21 than the radiator 120 of the first radiating element 100, and the radiator 120 of the first radiating element 100 is farther from the reflector 21 than the radiator 220 of the second radiating element 200. Moreover, as can be seen more clearly in combination with FIG. 8A, when viewed from a direction perpendicular to the surface of the reflector 21, the radiator 320 of the third radiating element 300 covers at least a part of the radiator 120 of the first radiating element 100, and the radiator 120 of the first radiating element 100 covers at least a part of the radiator 220 of the second radiating element 200.

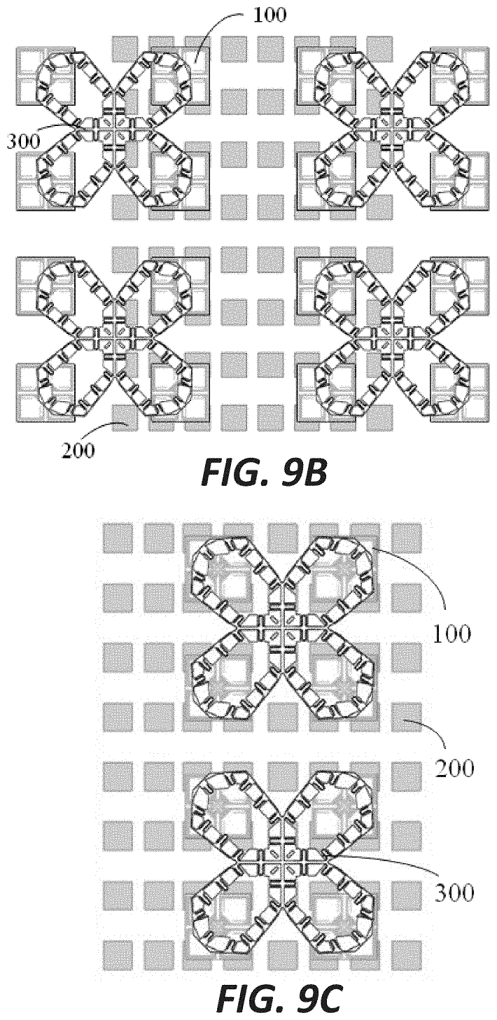

FIGS. 9A to 9C show several exemplary compact layouts of the multi-band base station antenna 20. In some embodiments, the multi-band base station antenna 20 may include a plurality of first radiating elements 100, a plurality of second radiating elements 200, and a plurality of third radiating elements 300, and they may be arranged such that, when viewed from a direction perpendicular to the surface of the reflector 21, each third radiating element 300 at least partially overlaps with one or more first radiating elements 100, and each first radiating element 100 at least partially overlaps with one or more second radiating elements 200. In some examples, when viewed from a direction perpendicular to the surface of the reflector 21, each first radiating element 100 of the one or more first radiating elements 100 with which each third radiating element 300 at least partially overlaps is located below a corresponding dipole arm of the third radiating element 300, and each second radiating element 200 of the one or more second radiating elements 200 with which each first radiating element 100 at least partially overlaps is located below a corresponding dipole arm of the first radiating element 100. For example, FIG. 9A shows a layout of two columns of third radiating elements 300, two columns of first radiating elements 100, and eight columns of second radiating elements 200, FIG. 9B shows a layout of two columns of third radiating elements 300, four columns of first radiating elements 100, and eight columns of second radiating elements 200, and FIG. 9C shows a layout of one column of third radiating elements 300, two columns of first radiating elements 100, and eight columns of second radiating elements 200.

As previously mentioned, in a conventional multi-band base station antenna, when a high-band (for example, 3.3 GHz to 4.2 GHz or a part thereof) radiating element covers a mid-band (for example, 1.7 GHz to 2.7 GHz or a part thereof) radiating element and a mid-band (for example, 1.7 GHz to 2.7 GHz or a part thereof) radiating element covers a low-band (for example, 617 MHz to 960 MHz or a part thereof) radiating element, then the radiation pattern of the blocked radiating element of a higher frequency band will be severely distorted, leading to significant deterioration of the performance of the multi-band base station antenna. Therefore, lower frequency band radiating elements are generally arranged outside an array of higher frequency band radiating elements, or the spacing between the radiating elements is increased to avoid as much as possible the higher frequency band radiating elements being covered by the lower frequency band radiating elements to result in the distortion of the radiation pattern. However, this usually increases the size of the antenna, and this situation becomes more severe when the number of radiating elements included in the antenna increases and the operating frequency bands of the antenna increase. In contrast, in the multi-band base station antenna 20 according to the present disclosure, since the first radiating element 100 is cloaked to the radiation in the second operating frequency range of the second radiating element 200, and the third radiating element 300 is cloaked to the radiation in the first operating frequency range of the first radiating element 100 and/or the second operating frequency range of the second radiating element 200, the radiation patterns of the first radiating element 100 and the second radiating element 200 may not be significantly affected even if the radiator 120 of the first radiating element 100 covers at least a part of the radiator 220 of the second radiating element 200 and the radiator 320 of the third radiating element 300 covers at least a part of the radiator 120 of the second radiating element 100.

In some embodiments, a radiator of the third radiating element is farther from the reflector than a radiator of the first radiating element and is farther from the reflector than a radiator of the second radiating element, and when viewed from a direction perpendicular to the surface of the reflector, at least one of the dipole arms of the radiator of the third radiating element may cover at least a part of the radiator of the first radiating element, and at least another one of the dipole arms of the radiator of the third radiating element may cover at least a part of the radiator of the second radiating element, wherein the branch conductive segment of the at least one of the dipole arms of the radiator of the third radiating element may be configured such that a current induced by radiation in the first operating frequency range in a portion, to which the branch conductive segment is connected, of the trunk conductive segment of the dipole arm is opposite to a current induced in the branch conductive segment, and the branch conductive segment of the at least another one of the dipole arms of the radiator of the third radiating element may be configured such that a current induced by radiation in the second operating frequency range in a portion, to which the branch conductive segment is connected, of the trunk conductive segment of the dipole arm is opposite to a current induced in the branch conductive segment.

For example, as shown in FIG. 11, the dipole arms 302A, 302C of the third radiating element 302 at least partially overlap with multiple first radiating elements 100, and the branch conductive segment of the dipole arm 302A, 302C is configured such that a current induced by radiation in the first operating frequency range of the first radiating element 100 in a portion, to which the branch conductive segment is connected, of the trunk conductive segment of the dipole arm 302A, 302C is opposite to a current induced in the branch conductive segment; the dipole arms 302B, 302D of the third radiating element 302 at least partially overlap with multiple second radiating elements 200, and the branch conductive segment of the dipole arm 302B, 302D is configured such that a current induced by radiation in the second operating frequency range of the second radiating element 200 in a portion, to which the branch conductive segment is connected, of the trunk conductive segment of the dipole arm 302B, 302D is opposite to a current induced in the branch conductive segment. Since the first operating frequency range of the first radiating element 100 is lower than the second operating frequency range of the second radiating element 200, the branch conductive segment of the dipole arm 302A, 302C may be configured to have a length longer than that of the branch conductive segment of the dipole arm 302B, 302D. It will be appreciated that, the branch conductive segment of each dipole arm of the third radiating element 302 in the multi-band base station antenna may be configured accordingly based on how the dipole arm overlaps with first radiating element(s) 100 and/or second radiating element(s) 200.

In addition, in some embodiments, in order to reduce the effect of the first radiating element 100 on the third radiating element 300, a common mode tuning circuit design may also be used in the feed stalk 110 of the first radiating element 100, as shown in FIG. 8B. In some embodiment, each of the first dipole arm to the fourth dipole arm of the firs radiating element 100 may have an electrical length which is about three quarters of the wavelength corresponding to the center frequency of the first operating frequency range of the first radiating element 100. In such case, the dipoles of the radiator of the first radiating element 100 may be high impedance dipoles which may have significantly reduced adverse influence on the radiation pattern of the third radiating element 300, which may be due to the effectively suppressed common mode resonance phenomenon.

In the multi-band base station antenna 20 according to the present disclosure, the existence of the first radiating element 100 does not affect or has little effect on the operation of the second radiating element 200, and the existence of the third radiating element 300 does not affect or has little effect on the operation of the first radiating element 100 and the second radiating element 200. Therefore, the arrangement of the first radiating element 100, the arrangement of the second radiating element 200, and the arrangement of the third radiating element 300 can be freely considered separately without worrying that an overlapping layout of them will affect the operating performance of one other. Therefore, the multi-band base station antenna 20 according to the present disclosure can maintain high performance while achieving high integration and miniaturization.

The terms “left”, “right”, “front”, “rear”, “top”, “bottom”, “upper”, “lower”, “high”, “low” in the descriptions and claims, if present, are used for descriptive purposes and not necessarily used to describe constant relative positions. It should be understood that the terms used in this way are interchangeable under appropriate circumstances, so that the embodiments of the present disclosure described herein, for example, can operate on other orientations that differ from those orientations shown herein or otherwise described. For example, when the device in the drawing is turned upside down, features that were originally described as “above” other features can now be described as “below” other features. The device may also be oriented by other means (rotated by 90 degrees or at other locations), and at this time, a relative spatial relation will be explained accordingly.

In the Specification and claims, when an element is referred to as being “above” another element, “attached” to another element, “connected” to another element, “coupled” to another element, or “contacting” another element”, the element may be directly above another element, directly attached to another element, directly connected to another element, directly coupled to another element, or directly contacting another element, or there may be one or multiple intermediate elements. In contrast, if an element is described “directly” “above” another element, “directly attached” to another element, “directly connected” to another element, “directly coupled” to another element or “directly contacting” another element, there will be no intermediate elements. In the Specification and claims, a feature that is arranged “adjacent” to another feature, may denote that a feature has a part that overlaps an adjacent feature or a part located above or below the adjacent feature.

As used herein, the word “exemplary” means “serving as an example, instance, or illustration” rather than as a “model” to be copied exactly. Any realization method described exemplarily herein is not necessarily interpreted as being preferable or advantageous over other realization methods. Moreover, the present disclosure is not limited by any expressed or implied theory given in the technical field, background art, summary of the invention, or specific implementation methods.

As used herein, the word “substantially” means comprising any minor changes caused by design or manufacturing defects, device or component tolerances, environmental influences, and/or other factors. The word “substantially” also allows the gap from the perfect or ideal situation due to parasitic effects, noise, and other practical considerations that may be present in the actual realization.

In addition, for reference purposes only, “first”, “second” and similar terms may also be used herein, and thus are not intended to be limitative. For example, unless the context clearly indicates, the words “first”, “second” and other such numerical words involving structures or elements do not imply a sequence or order.

It should also be understood that when the term “include/comprise” is used in this text, it indicates the presence of the specified feature, entirety, step, operation, unit and/or component, but does not exclude the presence or addition of one or more other features, entireties, steps, operations, units and/or components and/or combinations thereof.

In the present disclosure, the term “provide” is used in a broad sense to cover all ways of obtaining an object, so “providing an object” includes but is not limited to “purchase”, “preparation/manufacturing”, “arrangement/setting”, “installation/assembly”, and/or “order” of the object, etc.

As used herein, the term “and/or” includes any and all combinations of one or more of the associated listed items. The terms used herein are only for the purpose of describing specific embodiments, and are not intended to limit the present disclosure. As used herein, the singular forms “a”, “an” and “the” are also intended to include the plural forms, unless the context clearly dictates otherwise.

Those skilled in the art should realize that the boundaries between the above operations are merely illustrative. A plurality of operations can be combined into a single operation, which may be distributed in the additional operation, and the operations can be executed at least partially overlapping in time. Also, alternative embodiments may include multiple instances of specific operations, and the order of operations may be changed in other various embodiments. However, other modifications, changes and substitutions are also possible. Aspects and elements of all embodiments disclosed above may be combined in any manner and/or in conjunction with aspects or elements of other embodiments to provide multiple additional embodiments. Therefore, the Specification and attached drawings hereof should be regarded as illustrative rather than limitative.

Although some specific embodiments of the present disclosure have been described in detail through examples, those skilled in the art should understand that the above examples are only for illustration rather than for limiting the scope of the present disclosure. The embodiments disclosed herein can be combined arbitrarily without departing from the spirit and scope of the present disclosure. Those skilled in the art should also understand that various modifications can be made to the embodiments without departing from the scope and spirit of the present disclosure. The scope of the present disclosure is defined by the attached claims.

1. A radiating element, including:
a feed stalk; and
a radiator mounted on the feed stalk, the radiator including:
a first dipole along a first axis, the first dipole including a first dipole arm and a second dipole arm; and
a second dipole that extends along a second axis that is perpendicular to the first axis, the second dipole including a third dipole arm and a fourth dipole arm,
wherein each of the first dipole arm to the fourth dipole arm includes a trunk conductive segment and a branch conductive segment, the branch conductive segment having a first end that is connected to the trunk conductive segment and a second end that is open,
wherein the branch conductive segment is configured such that a first current induced by radiation, in a preselected frequency range that is higher than an operating frequency range of the radiating element, in a portion of the trunk conductive segment that connects to the branch conductive segment, is opposite to a second current induced in the branch conductive segment.

2. The radiating element according to claim 1, wherein the branch conductive segment of each of the first dipole arm to the fourth dipole arm is connected to the respective trunk conductive segment of each of the first dipole arm to the fourth dipole arm at respective positions at which the current induced in the respective trunk conductive segments of the first dipole arm to the fourth dipole arm by the radiation in the preselected frequency range reaches a maximum value.

3. The radiating element according to claim 1, wherein the branch conductive segment of each of the first dipole arm to the fourth dipole arm has a length between one-eighth to one quarter of a wavelength corresponding to a center frequency of the preselected frequency range.

4. The radiating element according to claim 1, wherein each of the first dipole arm to the fourth dipole arm includes a plurality of branch conductive segments,

5. The radiating element according to claim 4, wherein the number of branch conductive segments included in each of the first dipole arm to the fourth dipole arm is an even number.

6. The radiating element according to claim 4, wherein the branch conductive segments of each of the first dipole arm and the second dipole arm are arranged symmetrically about the first axis, and the branch conductive segments of each of the third dipole arm and the fourth dipole arm are arranged symmetrically about the second axis.

7. (canceled)

8. The radiating element according to claim 4, wherein:
the branch conductive segments of each of the first dipole arm to the fourth dipole arm are all arranged inside a boundary defined by the trunk conductive segment of the respective first dipole arm to the fourth dipole arm; or
the branch conductive segments of each of the first dipole arm to the fourth dipole arm are all arranged outside the boundary defined by the trunk conductive segment of the respective first dipole arm to the fourth dipole arm; or
some of the branch conductive segments of each of the first dipole arm to the fourth dipole arm are arranged outside the boundary defined by the trunk conductive segment of the dipole arm, while others are arranged inside the boundary defined by the trunk conductive segment of the dipole arm; or
the branch conductive segment of at least one of the first dipole arm to the fourth dipole arm overlaps with the trunk conductive segment of the dipole arm in length direction thereof.

9. The radiating element according to claim 1, wherein the branch conductive segment of the first dipole arm includes a first sub-branch conductive segment and a second sub-branch conductive segment, the first sub-branch conductive segment and the second sub-branch conductive segment are connected to the trunk conductive segment of the first dipole arm at the same position, and wherein:
the first sub-branch conductive segment is arranged inside a boundary defined by the trunk conductive segment of the first dipole arm and the second sub-branch conductive segment is arranged outside the boundary defined by the trunk conductive segment of the first dipole arm; or
the first sub-branch conductive segment and the second sub-branch conductive segment are both arranged outside the boundary defined by the trunk conductive segment of the first dipole arm; or
the first sub-branch conductive segment and the second sub-branch conductive segment are both arranged inside the boundary defined by the trunk conductive segment of the first dipole arm; or
the first sub-branch conductive segment is arranged inside or outside the boundary defined by the trunk conductive segment of the first dipole arm and the second sub-branch conductive segment overlaps with the trunk conductive segment of the first dipole arm in length direction thereof.

10. The radiating element according to claim 1, wherein the trunk conductive segment of each of the first dipole arm to the fourth dipole arm comprises a single closed conductive segment.

11. The radiating element according to claim 1, wherein the trunk conductive segment of each of the first dipole arm to the fourth dipole arm comprises a first conductive segment and a second conductive segment which are connected to each other at their first ends proximal to the feed stalk and separated by a gap at their second ends opposite the first ends.

12-16. (canceled)

17. The radiating element according to claim 1, wherein the branch conductive segment of each of the first dipole arm to the fourth dipole arm is configured such that a current induced by radiation in a respective one of a preselected plurality of frequency ranges higher than the operating frequency range of the radiating element in a portion, to which the branch conductive segment is connected, of the trunk conductive segment of the dipole arm is opposite to a current induced in the branch conductive segment, the respective ones of the plurality of frequency ranges being different from each other.

18. A multi-band base station antenna, including:
a reflector;
a first radiating element mounted on the reflector, the first radiating element being configured to operate in a first operating frequency range; and
a second radiating element mounted on the reflector, the second radiating element being configured to operate in a second operating frequency range that is higher than the first operating frequency range,
wherein the first radiating element is the radiating element according to claim 1, and the branch conductive segment of each dipole arm of the first radiating element is configured such that a current induced by radiation in the second operating frequency range in a portion, to which the branch conductive segment is connected, of the trunk conductive segment of the dipole arm is opposite a current induced in the branch conductive segment.

19. The multi-band base station antenna according to claim 18, wherein the radiator of the first radiating element is farther from the reflector than a radiator of the second radiating element, and when viewed from a direction perpendicular to the surface of the reflector, the radiator of the first radiating element covers at least a part of the radiator of the second radiating element.

20. The multi-band base station antenna according to claim 18, wherein the multi-band base station antenna includes a plurality of first radiating elements and a plurality of second radiating elements, and the plurality of first radiating elements and the plurality of second radiating elements are arranged such that, when viewed from a direction perpendicular to the surface of the reflector, at least half of the first radiating elements at least partially overlap one or more respective second radiating elements.

21. The multi-band base station antenna according to claim 20, wherein, when viewed from a direction perpendicular to the surface of the reflector, each of the one or more second radiating elements with which each first radiating element at least partially overlaps is located below a corresponding dipole arm of that first radiating element.

22. (canceled)

23. The multi-band base station antenna according to claim 18, wherein the multi-band base station antenna further includes a third radiating element mounted on the reflector, and the third radiating element is configured to operate in a third operating frequency range which is lower than the first operating frequency range.

24. The multi-band base station antenna according to claim 23, wherein the third radiating element is configured to be cloaked to radiation in the first operating frequency range and/or the second operating frequency range.

25-27. (canceled)

28. The multi-band base station antenna according to claim 24, wherein a radiator of the third radiating element is farther from the reflector than a radiator of the first radiating element, the radiator of the first radiating element is farther from the reflector than a radiator of the second radiating element, and when viewed from a direction perpendicular to the surface of the reflector, the radiator of the third radiating element covers at least a part of the radiator of the first radiating element, and the radiator of the first radiating element covers at least a part of the radiator of the second radiating element.

29. The multi-band base station antenna according to claim 24, wherein the multi-band base station antenna includes a plurality of first radiating elements, a plurality of second radiating elements, and a plurality of third radiating elements, and the plurality of first radiating elements, the plurality of second radiating elements, and the plurality of third radiating elements are arranged such that, when viewed from a direction perpendicular to the surface of the reflector, each third radiating element at least partially overlaps with one or more first radiating elements, and each first radiating element at least partially overlaps with one or more second radiating elements.

30. The multi-band base station antenna according to claim 29, wherein, when viewed from a direction perpendicular to the surface of the reflector, each of the one or more first radiating elements with which each third radiating element at least partially overlaps is located below a corresponding dipole arm of that third radiating element, and each of the one or more second radiating elements with which each first radiating element at least partially overlaps is located below a corresponding dipole arm of that first radiating element.

31-32. (canceled)
